(19) United States
(12) Patent Application Publication
(10) Pub. No.: US 2002/0026452 A1
(43) Pub. Date: Feb. 28, 2002

(54) Internet based employee/executive recruiting system and method

(76) Inventors: Jason Baumgarten, Greenwich, CT (US); Claudia Kelly, Greenwich, CT (US)

Correspondence Address: MCDERMOTT, WILL & EMERY, 600 13th Street, N.W., Washington, DC, 20005-3096, US

(21) Appl. No.: 09/858,881

(22) Filed: May 17, 2001

Related U.S. Application Data
(60) Provisional application No. 60/204,776, filed on May 17, 2000.

(51) Int. Cl. G06F 7/00

(52) U.S. Cl. 707/104.1; 707/1

(57) ABSTRACT

A website includes access to a database of job listings so that users can search the listings according to certain criteria as well as automatically be notified when a matching listing exits. Potential candidates interested in a particular matching position are presented with an online exam, based on the position, to eliminate unqualified candidates. Those candidates that match the job criteria and successfully complete the exam are then assessed off-line by an assessment specialist skilled and experienced at evaluating candidates for job openings, especially executive jobs two or three levels below the Chief Executive Officer level. A select few candidates are then interviewed, for example, by telephone or videoconference to further asses their fit with the job position. From the interview results a set of candidates are presented to the employer. To attract candidates to the web site, an adaptive predictive system is available for use that allows a candidate to input their current job position, their desired career goals and receive as output career path guidance which shows those positions that will help them reach their career goals.

### RELATED APPLICATIONS

The present application claims the benefit of the following provisional patent application, which is hereby incorporated by reference in its entirety: Ser. No. 60/204,776 entitled INTERNET BASED EMPLOYEE/EXECUTIVE RECRUITING filed on May 17, 2000 by Jason Baumgarten and Claudia Kelly.

### FIELD OF THE INVENTION

The present invention relates to executive recruiting and, more particularly, to online recruiting of executives.

### BACKGROUND OF THE INVENTION

The search for employees by employers and the search for jobs by candidates have historically been carried out through traditional advertising means as well as by word-of-mouth. In the recent past, a wide variety of Internet-based systems have entered the job-search and recruiting arena.

These Internet-based systems typical have a number of job postings which a candidate can search or a number of resumes that an employer can search. Through the technology of computers and the Internet, more and more job searchers and employers are finding it easier to fulfill coincident needs.

However, these Internet employment boards are limited in scope and function. At 25 relatively large companies, the job positions can be separated into three basic segments:

Executive (e.g., CEO, Senior Vice-President, etc.), middle-market (e.g., positions 3-4 levels below the CEO), and the lower levels. The Internet employment boards focus on the lower level segment of jobs and have not been utilized for recruiting candidates for the middle-market or higher.

Traditional methods for filling middle-market positions can take approximately 30 weeks and, therefore, could benefit from the reach and speed offered by the Internet. However, these positions are often critical to the business, require careful selection of a pool of candidates, and benefit from human judgment and experience when evaluating candidates. Accordingly, present methods for performing online employment-related searches do not meet the needs for filling middle-market and higher positions.

### SUMMARY OF THE INVENTION

The present invention relates to systems and methods for combining the speed and capabilities of the Internet and the experience of traditional recruiting firms to quickly and accurately fill middle-market employment opportunities.

One aspect of the present invention relates to a method for combining online and offline analysis of one or more candidates to identify a set of the one or more candidates that match a position. According to this aspect, a plurality of profiles are received on-line, each profile associated with a candidate; a determination is made regarding which of the plurality of profiles match the position in order to generate a set of qualified candidates; and, then the set of qualified candidates are assessed through an off-line interview to generate a set of matched candidates.

Another aspect of the present invention relates to a method for identifying one or more candidates for a position. According to this aspect, a plurality of profiles are received, each of the profiles associated with one of a plurality of candidates; a job listing is received that describes characteristics of the position; and an examination is generated to test knowledge relating to the position. A first set of candidates whose profiles match the job listing are selected and provided with the on-line examination, and in response to the examination, answers are received from the candidates. Next, a determination is made, based on the sets of answers, which of the first set of candidates exhibit a predetermined level of knowledge relating to the position, in order to generate a second set of candidates. Based on the candidate profiles and the examination answers, an off-line assessment is made regarding which of the second set of candidates to interview, in order to generate a third set of candidates which are then interviewed off-line. Ultimately one or more of the interviewed candidates is presented to the entity related to the job posting for potential employment.

An additional aspect of the present invention relates to a method for performing an employment search. According to this aspect of the invention, a query from a candidate is received that relates to available job postings; those available job posting that match the query are then identified and forwarded to the sender of the query. If the sender of the query indicates an interest in one of the matched job postings, then a on-line questionnaire and examination is forwarded to the sender of the query. In response, a candidate profile A and set of answers is received from the sender of the query. An off-line assessment, based on the profile and the answers, is then made whether to select the sender of the query for an interview. If selected, then the interview occurs off-line to determine how well the sender of the query matches the particular job posting.

A further aspect of the present invention relates to a method for providing career advice. According to this aspect, a current employment position and a desired employment position are received; a predictive model is used to predict one or more intermediate career paths between the current and desired position; and these predictions are forwarded to a user.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary hardware environment for an embodiment of the present invention.

FIG. 2 illustrates a logical flowchart of recruiting executive employees according to an embodiment of the present invention.

FIG. 3 illustrates a flowchart for an executive recruiting system in accordance with an embodiment of the present invention.

FIG. 4 illustrates a flowchart for a predictive career path system in accordance with an embodiment of the present invention.

FIG. 5 illustrates exemplary results of a predictive career path system in accordance with an embodiment of the present invention.

### DETAILED DESCRIPTION

A method and system for providing executive recruiting over the Internet are described herein. In the following description, for purposes of explanation, numerous specific details are set forth in order to provide a thorough understanding of the present invention. It will be apparent, however, to one of ordinary skill in the art that the present invention may be practiced without these specific details. In other instances, well-known structures and devices are shown in block diagram form in order to avoid unnecessarily obscuring the present invention.

### Exemplary Hardware Environment

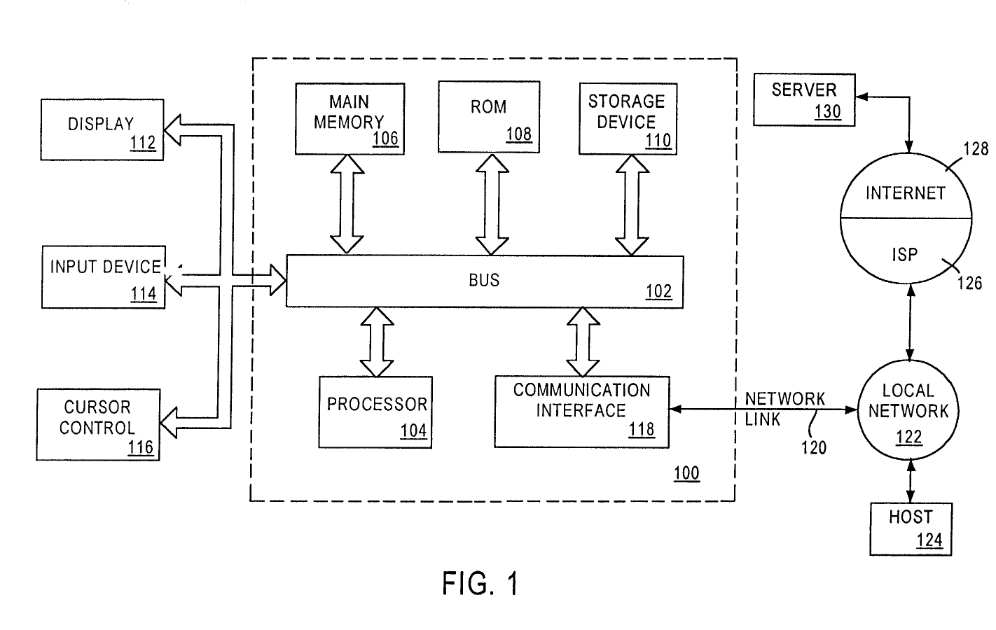

In at least one embodiment of the present invention described herein, the executive recruiting methods and systems are implemented by a central server, or servers, located on the Internet that can communicate with candidates, system personnel, and employers through network-capable communication protocols such as e-mail and the web. Portions of the invention are intended to be implemented on or over a network such as the Internet. An example of such a network is described in FIG. 1, attached.

FIG. 1 is a block diagram that illustrates a computer system 100 upon which an embodiment of the invention may be implemented. Computer system 100 includes a bus 102 or other communication mechanism for communicating information, and a processor 104 coupled with bus 102 for processing information. Computer system 100 also includes a main memory 106, such as a random access memory (RAM) or other dynamic storage device, coupled to bus 102 for storing information and instructions to be executed by processor 104. Main memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT), for displaying information to a computer user. An input device 114, including alphanumeric and other keys, is coupled to bus 102 for communicating information and command selections to processor 104. Another type of user input device is cursor control 116, such as a mouse, a trackball, or cursor direction keys for communicating direction information and command selections to processor 104 and for controlling cursor movement on display 112. This input device typically has two degrees of freedom in two axes, a first axis (e.g., x) and a second axis (e.g., y), that allows the device to specify positions in a plane.

Computer system 100 operates in response to processor 104 executing one or more sequences of one or more instructions contained in main memory 106. Such instructions may be read into main memory 106 from another computer-readable medium, such as storage device 110. Execution of the sequences of instructions contained in main memory 106 causes processor 104 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 104 for execution. Such a medium may take many forms, including but not limited to, non-volatile media, volatile media, and transmission media. Non-volatile media includes, for example, optical or magnetic disks, such as storage device 110. Volatile media includes dynamic memory, such as main memory 106. Transmission media includes coaxial cables, copper wire and fiber optics, including the wires that comprise bus 102. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 104 for execution. For example, the instructions may initially be carried on a magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector can receive the data carried in the infrared signal and appropriate circuitry can place the data on bus 102. Bus 102 carries the data to main memory 106, from which processor 104 retrieves and executes the instructions. The instructions received by main memory 106 may optionally be stored on storage device 110 either before or after execution by processor 104.

Computer system 100 also includes a communication interface 118 coupled to bus 102. Communication interface 118 provides a two-way data communication coupling to a network link 120 that is connected to a local network 122. For example, communication interface 118 may be an integrated services digital network (ISDN) card or a modem to provide a data communication connection to a corresponding type of telephone line. As another example, communication interface 118 may be a local area network (LAN) card to provide a data communication connection to a compatible LAN. Wireless links may also be implemented. In any such implementation, communication interface 118 sends and receives electrical, electromagnetic or optical signals that carry digital data streams representing various types of information.

Network link 120 typically provides data communication through one or more networks to other data devices. For example, network link 120 may provide a connection through local network 122 to a host computer 124 or to data equipment operated by an Internet Service Provider (ISP) 126. ISP 126 in turn provides data communication services through the world wide packet data communication network now commonly referred to as the “Internet” 128. Local network 122 and Internet 128 both use electrical, electromagnetic or optical signals that carry digital data streams. The signals through the various networks and the signals on network link 120 and through communication interface 118, which carry the digital data to and from computer system 100, are exemplary forms of carrier waves transporting the information.

Computer system 100 can send messages and receive data, including program code, through the network(s), network link 120 and communication interface 118. In the Internet example, a server 130 might transmit a requested code for an application program through Internet 128, ISP 126, local network 122 and communication interface 118. The received code may be executed by processor 104 as it is received, and/or stored in storage device 110, or other non-volatile storage for later execution. In this manner, computer system 100 may obtain application code in the form of a carrier wave.

### Executive Recruiting

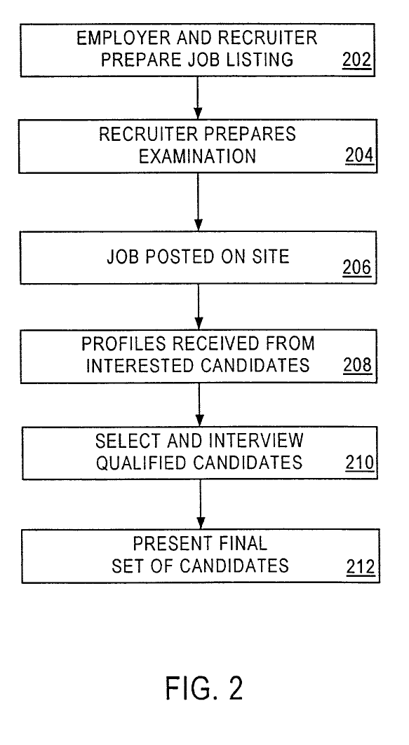

The flowchart of FIG. 2 provides an overview of providing an executive recruiting system in accordance with an embodiment of the present invention. In this embodiment, a recruiting firm has established a web site that is accessible by job seekers. This web site includes a number of job postings and can receive information from a candidate as well. As with conventional web sites, users can be required to register or log on to the site so that the operators can control access to the site and track the statistics related to the transactions occurring on the site.

In step 202, an employer contacts a recruiting firm with a job position that needs filling. This job need is translated into a job description or listing that provides the details about the job. It is typically a short paragraph describing the job title, industry, functions, locations, responsibilities, candidate characteristics, salary ranges and benefits.

Next, in step 204, the recruiting firm prepares an examination for potential candidates to identify those candidate not in possession of the required skills and knowledge for the listed position. The recruiting firm, in preparing the exam, relies on their experience and knowledge of filling comparable positions in the past and receives assistance from the employer as well. The exam is preferably a short (e.g., 6 to 10 questions) multiple-choice exam with the questions designed not to qualify candidates but, instead, to eliminate some candidates who apply for the job.

In step 206, the job description is posted on the web site to be accessible by candidates. In one embodiment, the web site can already have a database of candidate profiles that can be searched to see if they match the new position. An e-mail or other message can be sent to any matching profiles to alert them of the new job position.

Otherwise, in step 208, candidates access the web site to search the posted job listings and when a desired job is located, a candidate submits an indication of their interest in the position as well as a personal profile. Submitting the profile can be a multi-step process in which one of the steps is the completion of the exam prepared in step 204.

From the submitted profiles and exams, the recruiting firm can select, in step 210, candidates that appear to be well matched to the position. The recruiting firm can then perform interviews with the this selected group of candidates. In a preferred embodiment, the interviews take place via telephone or via videoconference. In this way, the speed of the process is not slowed down by insisting on an in-person interview. Because the recruiting firm has consulted with the employer and has experience in the arena of recruiting, the candidates can be evaluated for their fit with the specific position and employer.

After the interviews are completed, qualified candidates are presented, in step 212, to the employer as potential employees. The presenting of candidates can take place in batches or one-by-one as each qualified candidate is identified. Unlike conventional online recruiting methods which blindly dump resumes on an employer, the present invention includes more than one human judgment step to ensure only qualified candidates make it through the process. As for payment, the costs of operating the web site could be distributed between both the candidates and the employers. However, to maintain similarity with conventional offline search firms, the operating costs can be borne by the employers based on the actual filling of a position. For example, a fee could be charged by the website operator to the employers that is a predetermined percentage of the first year's compensation of a position filled using the website.

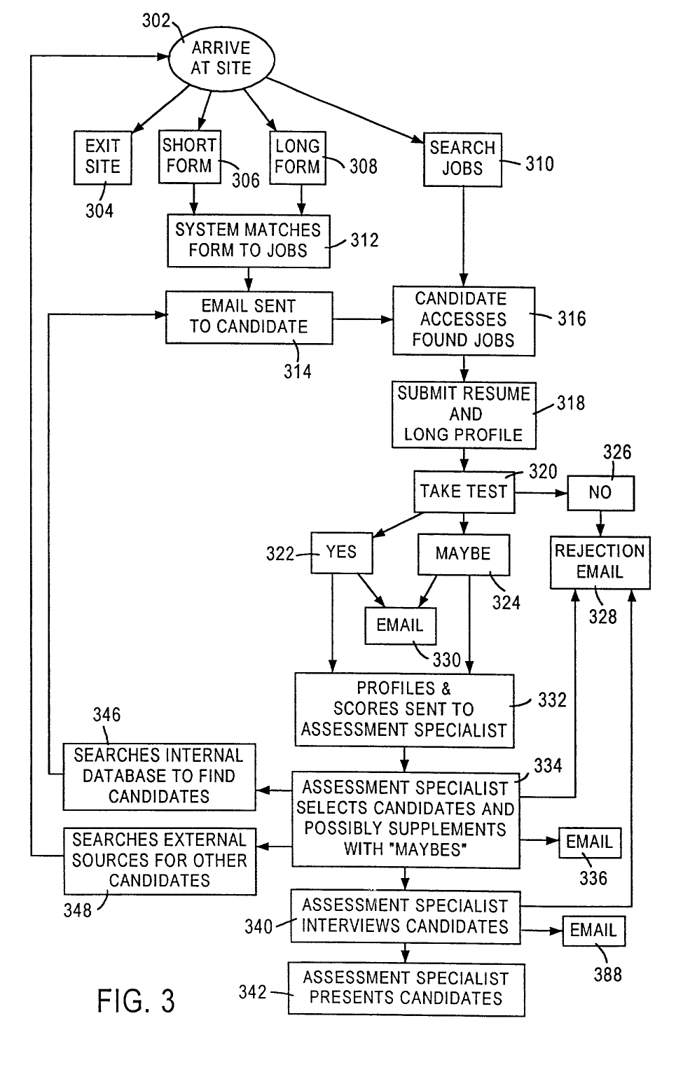

The flowchart of FIG. 3 provides the details of an executive recruiting system according to a preferred embodiment of the present invention. Similar to the embodiment described with relation to FIG. 2, this embodiment includes a web site that augments a traditional recruiting firm by providing a online recruiting method for executive positions. This web site allows access to a database of job listings, connects with an exam repository that stores exams related with each job posting, and connects with a database of candidate profiles. One particular aspect of this embodiment is that is caters to both the active as well as the passive job seeker. Those actively searching for jobs can search the database for matching positions; while those that are more passive can wait to receive an e-mail from the system that a matching position is available.

In step 302, candidates arrive at the web site and, among other content, can select four options. The other content of the site can be geared towards the information and features that would attract Internet-savvy executives. Of course, one option is to exit the site (step 304).

Another option is to complete, in step 306, a short form registration. Rather than requiring every user to complete a lengthy and time-consuming registration process, a minimal registration process option is provided. Preferably, the short-form registration process will not require personal information, with the exception of an e-mail address for contact purposes. Instead it will focus on identifying key criteria that will allow the recruiting system to match open jobs with interested candidates.

After selecting a username and password, candidates will be asked to provide information such as desired salary range, functional expertise, desired industry, geographic preference, company size preference, and an e-mail address. This information can be collected by having the user complete a form with pull down menus or free-form text boxes. By registering, a candidate will automatically be set-up to receive job matching e-mails.

A candidate can also choose to complete, in step 308, a long form registration process. This process will gather more detailed information than the short-form registration. As this longer form is ultimately needed to apply for a job, a candidate can save time later by completing the long-form registration initially. Furthermore, a long-form registration can be used by recruiting firm personnel to uncover additional matching jobs.

Exemplary information on the long form can include name, address, telephone number, educational information, employers, dates, job titles, foreign language skills, and a resume (either text or formatted attachment).

As the fourth alternative, a user of the web site can merely search for jobs in the database of job postings, in step 310, without completing any type of registration. Conventional keyword searching capability can be provided to allow a user to locate jobs that match a desired salary, location, skill set, etc. While the user can access, in step 316, any matching jobs, the user will eventually need to register to be considered for any position.

In step 312, the online recruiting system matches jobs descriptions with candidate profiles received during registration. The criteria for determining a matching position is similar to the short-form registration information. Members whose criteria match the job will be sent, in step 314, an e-mail notifying them of the match. The full text of the job description can also be included in the e-mail. There may also be a hypertext link to the job description on the recruiting website's system.

At this point, the candidate can decide whether or not to express an interest in the matching job. If they want to express interest, then they can click through the link to the web site. If they are not interested, then they can simply delete the e-mail.

Once the candidate clicks through the link, they can access, in step 316, the job posting. Preferably the candidate is once again presented with the same job description as in the e-mail to ensure they are indeed applying for the job about which they were e-mailed. Through a user control on the presented web page, the user will be given the option to express an interest in applying for the position.

The user then proceeds to step 318 to submit the information in the long-form profile. The user's web browser may contain a “cookie” to indicate whether they have completed a short-form or long-form registration. If the cookie exists, then the website presents the candidate's existing information to the candidate and offers an opportunity to update the information before applying for the position. If the cookie is not located, the website can prompt the user to enter a username and password. Using this login information the website can generate an associated long-form if it exists or request that one be filled out. However, if no cookie exists and the user has never registered with the website, then they will be prompted to register and complete the long-form registration. In the end, the candidate will either verify existing information or complete a new long-form required to apply for a given job. Once completed, the candidate can click on a hyperlink or other control to apply for the position.

By applying for a position, the user is automatically directed to the online exam associated with the desired job position. In a preferred embodiment, the candidate must take the exam, in step 320, and answer all the questions. Candidates fall into three categories: those that score high on the exam (step 322), those that fail the exam (step (326), and those whose scores are mediocre (step 324). The candidates who fail the exam are sent, in step 328, an e-mail notification that they are no longer being considered for the position. Those candidates in the other two groups are sent, in step 330, an e-mail informing them that they will receive correspondence in the future regarding the job position.

Also, the profiles and scores of each candidate that did not fail the exam are forwarded, in step 332, to recruiting firm personnel for assessment. This assessment specialist is particularly knowledgeable about the position, the exam, the employer and has experience with comparable positions. The assessment specialist selects a pool of candidates to proceed in the job fulfillment process. The assessment specialist has a number of options to ensure that a large pool of candidates is available for interviewing. First, the candidates who passed the exam may be large enough by itself. In this instance, the candidates with mediocre test results are sent, in step 328, an e-mail notification that they are no longer being considered for the position. If some of the mediocre candidates are needed to expand the candidate pool, then these candidates, along with the other qualified candidates, are sent, in step 336, and e-mail notification for scheduling an interview.

If the candidate pool is not big enough, then the assessment specialist can search, in step 346, the database of candidate long-forms to identify registered users that qualify for the position. These candidates, if they have not already applied for this job, are sent, in step 314, an e-mail identifying the position and asking them to apply for it.

Another alternative, if the candidate pool is still too small, is for the assessment specialist to search, in step 348, outside sources (e.g., job boards, Internet sites, etc.) for qualified candidates. These candidates are then sent a copy of the job description and an invitation to visit the website. As seen from the flowchart, all users that are identified through a database search will have to go through the same process as the other members. Those that make the first cut will be informed that they will be contacted for an interview.

In step 340, the assessment specialist interviews those candidates who made it through the first-cut to identify those candidates who best fit the employers needs. This off-line assessment is similar to interviews used by traditional recruiting firms and conducted. However, in the interest of time and cost, the interviews can take place over the phone or via videoconference. From the interviewed candidates, a set is selected to be presented, in step 342, to the employer and notified accordingly, in step 338, by e-mail or other means. Those not selected after the interviews will be sent, in step 328, appropriate notification.

Accordingly, a recruiting firm can advantageously use the Internet to speed-up the executive search process while still providing the consulting and experience to ensure that the employer receives the best sent of likely candidates for a position.

### Adaptive Career Mentor

The online recruiting method described herein has particular applicability to a traditional employment search firm that already has an established base of employers and candidates. The employer base can be tapped to generate a number of middle-market jobs that would likely have been filled using traditional methods. Also, the recognition by candidates that jobs from respected and established employers are available through the online recruiting system would help attract candidates to the online site. Furthermore, the already established database of quality candidates by the traditional recruiting firm would, in turn, entice employers to use the online service to fill middle-market employment needs.

The online recruiting system can also attract candidates to the website by offering content and information of interest to Internet-savvy executives such as career advice, news, and other similar information. In particular, advice about a desired career path progression and the steps to fulfill it would help attract a number of executive-level candidates. As the traditional recruiting firm possesses extensive knowledge and experience in placing executives in the middle-market, they are in the position to provide career path guidance that will attract candidates and, consequently, attract employers.

The recruiting web site, in addition to the choices and options already described, can offer a visitor to the site the option for participating in an Internet-based adaptive predictive system. A predictive system can use neural nets, heuristics, and other artificial intelligence technologies to learn the relationship between various inputs and outputs. The resulting predictive model assigns weights between designated inputs and corresponding outputs on the basis of results during “training” of the model. As a result, the model can be used to predict an output from a given set of inputs.

The present predictive system relates to career path progression. A database of career paths such as from resumes or other historical data gathered by the recruiting firm can be used to train the predictive model. To use the system, a candidate enters a starting point and an ending point. The starting point is the candidate's current employment position and the ending point is the career aspirations of the candidate. As for output, the system provides a personalized career path to get from the starting point to the ending point. This system can enable candidates to explore different career paths and determine the impact different jobs are likely to have on a specified career goal.

Other benefits of this predictive system include providing an assessment tool for prospective candidates (or employers) to analyze a specific point in a career path against a database of similar progressions and rate the speed of succession, salary, and other factors of a given position based on the known universe of backgrounds and the projected positions of similar profiles.

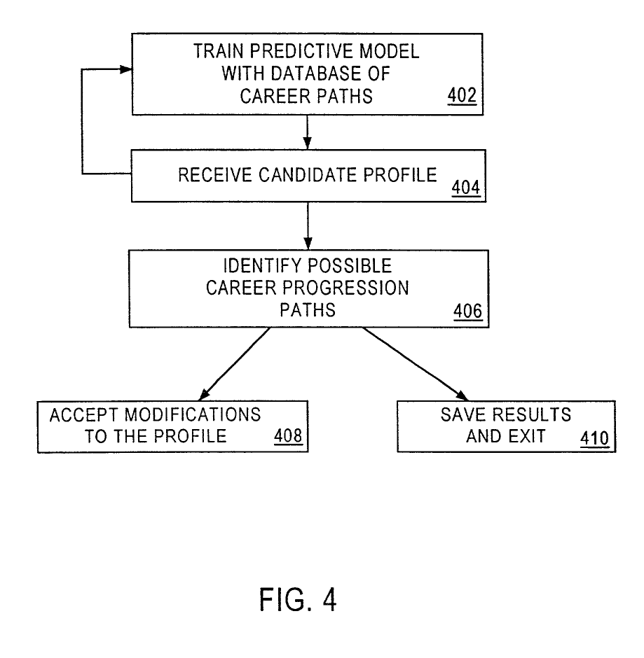

FIG. 4 illustrates the logical flow of a the career predictive system. In step 402, the predictive model is trained with historical data about career paths from resumes, database records and other sources of career information. Once the model is trained, a candidate visiting the web site will complete a profile, in step 404. An employer or other intermediary could also provide the profile on behalf of a candidate. This profile can include such characteristics as education, previous positions held, descriptions of employer information such as size, location and industry type. Other information could be included as well, such as professional test scores, professional certifications, skills inventory, psychological profiles and cultural fit exams. The profile also contains a section on career aspirations such as desired location, position title, employer characteristics descriptions, and time frames for reaching certain goals. As shown by the arrow back to step 402, the system can be adaptive in nature so as to adjust the predictive model in view of the profiles that are entered in step 404.

Next, in step 406, the predictive system identifies possible career paths to fill in the most likely steps between the background profile and the aspiration profile. The system can indicate probabilities of different steps along a path. In one embodiment, the potential positions displayed to the candidate can be limited to only those positions currently available on the recruiting web site or only those positions in a selected geographical area.

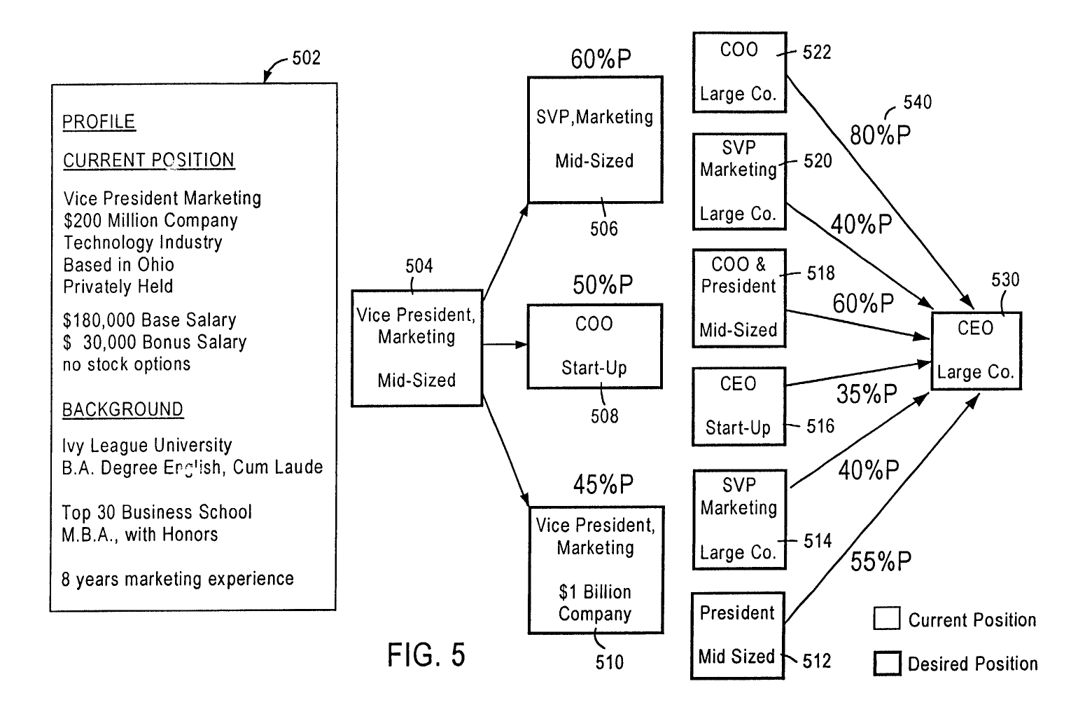

Diverting from FIG. 4 for a moment, FIG. 5 illustrates an exemplary graphical display of what can be provided to a candidate or other party by the predictive system. A candidate profile 502 includes a variety of information. The candidate's current position 504 is shown to the left of the progression. In this example, three possible next steps 506-510 are shown along with the probabilities of being selected for each such position. As shown, the positions include not only job titles but company descriptors as well. A second tier of positions 512-522 is shown (without probabilities) to indicate to the candidate how the next career steps depend on which path is selected. From each position in the second tier, the probabilities 540 of reaching the desired career goal 530 are shown.

Returning now to FIG. 4, the candidate has the opportunity to modify the profile, in step 406, to see the effect on the career path displayed in FIG. 5. Some likely modifications include adding a hypothetical position, adding educational criteria, changing a geographical location of a current position or a target position, changing an industry-type, changing the ultimate career goal, or changing the time spent in one or more positions. Once the changes are made, then flow returns to step 406 so that another career progression display can be generated.

In step 410, a candidate, or other user, can save the results and exit the system.

Using the adaptive career predictive system just described a user can asses questions such as:

Have I stayed in my current position or with my current employer the same, less or more than the average of my peer group?

Am I considering the fall range of possibilities for my next position?

Am I limiting myself by isolating my career search to a specific location?

What is the real benefit of pursuing additional education? How has it benefited my peer group? How many jobs are available for the most advantageous next step in my career?

Have I backed myself into a “career comer” or do I have lots of options?

### Summary

While this invention has been described in connection with what is presently considered to be the most practical and preferred embodiment, it is to be understood that the invention is not limited to the disclosed embodiment, but on the contrary, is intended to cover various modifications and equivalent arrangements included within the spirit and scope of the appended claims. The invention is capable of other and different embodiments and its several details are capable of modifications in various obvious respects, all without departing from the invention. Accordingly, the drawings and description are to be regarded as illustrative in nature, and not as restrictive.

What is claimed is:

1. A method for combining online and offline analysis of one or more candidates to identify a set of the one or more candidates that match a position, the method comprising the steps of:
receiving a plurality of profiles on-line, each profile associated with a candidate;
determining which of the plurality of profiles match the position to generate a set of qualified candidates; and
assessing the set of qualified candidates through an off-line interview to generate a set of matched candidates.

2. The method according to claim 1, further comprising the step of:
presenting the set of matched candidates to an entity associated with the position.

3. The method according to claim 1, wherein the step of receiving profiles includes the steps of:
presenting an on-line questionnaire; and
in response, receiving a profile from the one or more candidates.

4. The method according to claim 3, wherein the step of receiving profiles further includes the steps of:
presenting an examination based on knowledge related to the position; and
in response, receiving from each of the one or more candidates corresponding answers for the examination.

5. The method according to claim 3, wherein the step of determining matching profiles includes the steps of:
creating a position profile having a plurality of attributes; and
determining which of the plurality of profiles match the plurality of attributes of the position profile.

6. The method according to claim 4, wherein the step of determining matching profiles includes the step of:
determining for each of the one or more candidates whether the corresponding answers indicate the candidate has the knowledge related to the position.

7. The method according to claim 4, further comprising the steps of:
selecting off-line an intermediate set of candidates to interview based on the plurality of profiles and the corresponding answers; and
interviewing the intermediate set of candidates to further limit the set of qualified candidates.

8. The method according to claim 1, further comprising the steps of:
determining other candidates that match the position by searching other profiles, each of the other profiles associated with one of the other candidates; and
notifying the other candidates about the position.

9. The method according to claim 1, further comprising the steps of:
determining other candidates that match the position by searching at least one of the Internet and an external database; and
notifying the other candidates about the position.

10. A method for identifying one or more candidates for a position, the method comprising the steps of:
receiving a plurality of profiles, each of the profiles associated with one of a plurality of candidates;
receiving a job listing that describes characteristics of the position;
generating an examination to test knowledge relating to the position;
determining on-line, based on at least a portion of the profiles, which of the candidates match the characteristics of the position, to generate a first set of candidates;
providing on-line the examination to the first set of candidates;
in response, receiving from each of the first set of candidates a set of answers based on the examination;
determining, based on the sets of answers, which of the first set of candidates exhibit a predetermined level of knowledge relating to the position, to generate a second set of candidates;
assessing off-line, based on the profiles and the sets of answers, which of the second set of candidates to interview, to generate a third set of candidates;
interviewing off-line each of the third set of candidates to determine a fourth set of candidates; and
presenting to an entity associated with the position the fourth set of candidates.

11. The method according to claim 10, further comprising the step of:
receiving compensation from the entity, based on at least one candidate in the fourth set of candidates.

12. A method for performing an employment search comprising the steps of:
communicating with a first data repository storing a plurality of job postings; each posting having a corresponding first set of attributes;
communicating with a second data repository storing a plurality of on-line examinations, each examination associated with one of the plurality of job postings;
receiving a query related to the job postings, the query having a second set of attributes;
identifying which of the job postings match the received query based on a comparison of the corresponding first sets of attributes and the second set of attributes;
forwarding the identified matching job postings to the sender of the query;
in response, receiving an indication of interest in applying for a particular job posting of the identified matching job postings;
providing an on-line questionnaire to the sender of the query;
in response, receiving a candidate profile;
providing to the sender of the query the on-line examination associated with the particular job posting;
in response, receiving a set of answers;
assessing off-line whether or not to select the sender of the query for an interview based on the set of answers and the candidate profile;
interviewing off-line the sender of the query, if selected for the interview; and
determining, based on the interview, whether the sender of the query matches the particular job posting.

13. A method for providing career advice, the method comprising the steps of:
receiving at least a current position and a desired position about a candidate;
predicting one or more intermediate career paths between the current position and the desired positions, wherein each intermediate career path comprises one or more positions; and
forwarding the predicted one or more intermediate career paths to a user.

14. The method according to claim 13, further comprising the steps of:
training a predictive model using a plurality of historical career paths, wherein the step of predicting uses the predictive model.

15. The method according to claim 14, farther comprising the steps of:
receiving a previous employment profile about the candidate; and
adapting the predictive model based on the previous employment profile.

16. The method according to claim 15, further comprising the steps of:
receiving a modification to at least one of the profile, the current position, and the desired position;
modifying the predicted one or more intermediate career paths based on the received modification; and
forwarding the modified predicted one or more intermediate career paths to a user.

17. The method according to claim 13, further comprising the steps of:
calculating a probability associated with the candidate attaining each of the predicted one or more intermediate career paths; and
forwarding the calculated probabilities to the user.

18. A computer readable medium bearing instructions for combining online and offline analysis of one or more candidates to identify a set of the one or more candidates that match a position, said instructions being arranged to cause one or more processors upon execution thereof to perform the steps of:
receiving a plurality of profiles on-line, each profile associated with a candidate;
determining which of the plurality of profiles match the position to generate a set of qualified candidates; and
identifying the set of qualified candidates in order to permit assessing of the set of qualified candidates through an off-line interview to generate a set of matched candidates.

19. A computer readable medium bearing instructions for performing an employment search, said instructions being arranged to cause one or more processors upon execution thereof to perform the steps of:
communicating with a first data repository storing a plurality of job postings; each posting having a corresponding first set of attributes;
communicating with a second data repository storing a plurality of on-line examinations, each examination associated with one of the plurality of job postings;
receiving a query related to the job postings, the query having a second set of attributes;
identifying which of the job postings match the received query based on a comparison of the corresponding first sets of attributes and the second set of attributes;
forwarding the identified matching job postings to the sender of the query;
in response, receiving an indication of interest in applying for a particular job posting of the identified matching job postings;
providing an on-line questionnaire to the sender of the query;
in response, receiving a candidate profile;
providing to the sender of the query the on-line examination associated with the particular job posting;
in response, receiving a set of answers;
providing the received set of answers and candidate profile to an assessment specialist to allow:
off-line assessing of whether or not to select the sender of the query for an interview based on the set of answers and the candidate profile;
interviewing off-line the sender of the query, if selected for the interview; and
determining, based on the interview, whether the sender of the query matches the particular job posting.

20. A computer readable medium bearing instructions for providing career advice, said instructions being arranged to cause one or more processors upon execution thereof to perform the steps of:
receiving at least a current position and a desired position about a candidate;
predicting one or more intermediate career paths between the current position and the desired positions, wherein each intermediate career path comprises one or more positions; and
forwarding the predicted one or more intermediate career paths to a user.
